(19) United States
(12) Patent Application Publication
(10) Pub. No.: US 2011/0108271 A1
(43) Pub. Date: May 12, 2011

(54) ENHANCING HYDROCARBON RECOVERY

(75) Inventors: Jerald J. Hinkel, Houston, TX (US); Kevin W. England, Houston, TX (US); Dean Willberg, Tucson, AZ (US)

(73) Assignee: Schlumberger Technology Corporation, Cambridge, MA (US)

(21) Appl. No.: 12/914,463

(22) Filed: Oct. 28, 2010

Related U.S. Application Data
(63) Continuation-in-part of application No. 12/253,406, filed on Oct. 17, 2008, now abandoned.

(51) Int. Cl. E21B 43/25; C09K 8/58; E21B 43/00

(52) U.S. Cl. 166/270.1; 166/75.15; 166/90.1

(57) ABSTRACT

Recovery of hydrocarbon fluid from low permeability sources enhanced by introduction of a treating fluid is described. The treating fluid may include one or more constituent ingredients designed to cause displacement of hydrocarbon via imbibition. The constituent ingredients may be determined based on estimates of formation wettability. Further, contact angle may be used to determine wettability. Types and concentrations of constituent ingredients such as surfactants may be determined for achieving the enhanced recovery of hydrocarbons. The selection can be based on imbibition testing on material that has been disaggregated from the source formation.

### CROSS-REFERENCE TO RELATED APPLICATION

This application is a continuation-in-part of U.S. patent application Ser. No. 12/253,406, filed Oct. 17, 2008, and is related to commonly-assigned and simultaneously-filed U.S. patent application Ser. No. 12/253,426, entitled “Method of Hydrocarbon Recovery”, each of these applications also being incorporated by reference herein.

### FIELD

The patent specification is generally related to hydrocarbon recovery from low permeability sources. More particularly, this patent specification relates to enhanced hydrocarbon recovery from low permeability reservoirs using treatments formulated based on imbibition analysis of source material.

### BACKGROUND

Recovering hydrocarbons such as oil and gas from high permeability reservoirs is well understood. However, recovery of hydrocarbon resources from low-permeability reservoirs is difficult and less well understood. Consequently, operators have until recently tended to bypass low permeability reservoirs such as shales in favor of more conventional reservoirs such as sandstones and carbonates. A shale reservoir typically includes a matrix of small pores and may also contain naturally occurring fractures/fissures (natural fractures). These natural fractures are most usually randomly occurring on the overall reservoir scale. The natural fractures can be open (have pore volume) under in-situ reservoir conditions or open but filled in with material (have very little or no pore volume) later in geologic time; for example, calcite (CaCO₃). These fractures can also be in a closed-state (no pore volume) due to in-situ stress changes over time. Natural fractures in any or all of these states may exist in the same reservoir. For more complete understanding of the occurrence, properties, behavior, etc. of naturally fractured reservoirs in general, one may review the following references: Nelson, Ronald A., Geologic Analysis of Naturally Fractured Reservoirs (2nd Edition), Elsevier, and Aguilera, Roberto, Naturally Fractured Reservoirs, PennWell Publishing. The permeability of the shale pore matrix is typically quite low, e.g., in the less than one millidarcy range. In a shale gas reservoir, this presents a problem because the pore matrix contains most of the hydrocarbons. Since the low permeability of the pore matrix restricts fluid movement, it would be useful to understand how to prompt mass transfer of hydrocarbons from the pore matrix to the fracture network.

Research related to low permeability formations includes Katsube, T. J., “Shale permeability and pore-structure evolution characteristics”, Geological Survey of Canada, Current Research 2000-E15 (2000), which describes several pore structure models, and mercury intrusion and extrusion data. So-called “storage pores” that are dead-ended, but contain fluids, are identified from extrusion data. However, according to Katsube the storage pores do not contribute to the migration of fluids through the rock formation. Imbibition, a process where a wetting fluid spontaneously displaces a non-wetting fluid from a porous medium has long been recognized as an effective means to enhance recovery of oil from low permeability, naturally fractured reservoirs. For example, Hirasaki, G. and Zhang, D., “Surface Chemistry of Oil Recovery From Fractured, Oil-Wet Carbonate Formation”, SPE 80988 (2003) describe capillary pressure and the effects of surface chemistry on imbibition for oil recovery. Penny, G. S., Pursley, J. T., and Clawson, T. D., “Field Study of Completion Fluids to Enhance Gas Production in the Barnett Shale”, SPE 100434 (2006) and Paktinat, J., Pinkhouse, J. A., Williams, C., Clark, G. A., and Penny, G. S., “Field Case Studies: Damage Preventions Through Leakoff Control of Fracturing Fluids in Marginal/Low-Pressure Gas Reservoirs”, SPE 100417 (2006), which are related to stimulation treatments of shale, emphasize water sensitivity and the need to remove water from the well soon after treatments using aqueous fluids. Li, K. and Horne, R. N., “Characterization of Spontaneous Water Imbibition into Gas-Saturated Rocks”, SPE 62552 (2000), provided an early analysis of the process where water is spontaneously imbibed into gas-saturated rocks. The authors note that this process is important to water coning in cases where naturally fractured gas reservoirs are positioned over active aquifers. Experimental results using packs of glass beads and Berea cores showed water imbibition to be a piston-like displacement process. Based upon this observation, the authors formulated a theoretical model that accounts for both effective water permeability and capillary pressure. Generally, the permeability of the media was greater than 500 millidarcy (mD). Babadagli, T., Hatiboglu, C. U., “Analysis of counter-current gas-water capillary imbibition transfer at different temperatures”, Journal of Petroleum Science and Engineering 55 (2007) 277-93 describes the counter-current flow phenomenon. The authors speculate that imbibition in gas-liquid systems is different from the case of liquid-liquid systems as might be encountered in oil recovery. Despite a favorable mobility ratio, the authors point out that entrapment of the non-wetting gas phase is likely due to high surface tension. The authors also point out that an efficient matrix-fracture interaction based on the matrix characteristics could be achieved via controllable parameters such as the viscosity and surface tension of the injected fluid. Experiments using Berea cores indicate that less gas trapping occurs when the viscosity and interfacial tension of the imbibing fluid are lowered. The authors note lower surface tension at higher test temperature, e.g., 72.9 dynes/cm at 20 degC vs. 60.8 dynes/cm at 90 degC, and they discuss the effect of lower surface tension. The permeability of the porous media tested by Babadagli et al., a sandstone and a limestone, are 500 and 15 mD respectively, which are 5-6 orders of magnitude greater than the matrix permeability of typical gas shale reservoirs being developed today.

It is widely believed that water imbibition into a reservoir from a well that will be used for production is deleterious in several ways. See, for example, Bennion, D. B., et al., “Low Permeability Gas Reservoirs: Problems, Opportunities and Solutions for Drilling, Completion, Stimulation and Production,” SPE 35577, Gas Technology Conference, Calgary, Alberta, Canada, Apr. 28-May 1, 1996, and Bennion, D. B., et al., “Formation Damage Processes Reducing Productivity of Low Permeability Gas Reservoirs,” SPE 60325, 2000 SPE Rocky Mountain Regional/Low Permeability Reservoirs Symposium and Exhibition, Denver, Colo., Mar. 12-15, 2000. Imbibed water increases the water saturation and is thought to become trapped and to block hydrocarbon flow. If imbibed water is fresher (less salinity) than formation water, it may affect fresh water sensitive expanding clays. Furthermore, imbibition of water into formations such as shale during drilling may be responsible for spalling and wall collapse. For these reasons, operators often try to complete wells with non-aqueous fluids. Water invasion of reservoirs, except in water-flooding with distinct injectors and producers, is considered a damage mechanism and is to be avoided.

Bennion, et al. (2000) illustrate both the present understanding of one example of how capillary pressures lead to phase trapping of water and to blocking of hydrocarbon production, and give proposed solutions that are opposite the principles and method of the present Invention. Bennion, et al. (2000) teach that very low permeability gas reservoirs are typically in a state of capillary undersaturation, where the initial water (and sometimes oil) saturation is less than would be expected from conventional capillary mechanics for the pore system under consideration. Retention of fluids (phase trapping) is considered to be one of the major mechanisms of reduced productivity, even in successfully fractured completions in these types of formations. In a low permeability gas reservoir, due to the very small size of the pore throats and pore bodies, the tortuous nature of the pore system and the high degree of micro-porosity, the observed radii of curvature of the gas-liquid interfaces are very small, particularly at low water saturations, which gives rise to the higher capillary pressure values and higher irreducible water saturation values which are commonly associated with poor quality porous media. In general, as permeability and porosity decrease and the relative fraction of micro-porosity increases, both the capillary pressure and the irreducible water saturation tend to increase substantially.

Bennion, et al. (2000) further teach that often associated with this increase in trapped initial liquid saturation is a significant reduction in the net effective permeability to gas, caused by the occlusion of a large portion of the pore space by the irreducible and immobile trapped initial liquid saturation present. On a relative permeability basis, in general, the greater the value of the initial trapped fluid saturation, the less original reserves of gas in place are available for production, and also the lower the initial potential productivity of the matrix. In reservoir situations where exceptionally low matrix permeability is present, one finds that, if the reservoir is in a normally saturated condition (that is, if the reservoir is in free contact and capillary equilibrium with mobile water and is at a normal level of capillary saturation for the specific geometry of the porous media under consideration), Bennion, et al. (2000) teach that very high trapped initial liquid saturations tend to be present, and that it can be observed that in reservoir rocks of permeability to gas on an absolute basis of less than 0.1 mD, effective initial water saturations are often in the 60% plus region. This often results in significant reductions of the original reserves of gas in place in the porous media, and may also result in a very low or zero effective permeability to gas, as the gas saturation may be at or near the critical mobile value, and hence it will exhibit limited or no mobility when a differential pressure gradient is applied to the formation during production operations.

Therefore, Bennion, et al. (2000) teach that in most cases where very low permeability gas reservoirs are potentially productive, the reservoir exists in a situation where the reservoir sediments have been isolated from effective continual contact with a free water source which is capable of establishing an equilibrium and uniform capillary transition zone. They believe that a combination of long-term regional migration of gas through the isolated sediments (resulting in an extractive desiccating effect as temperature and pore pressure are increased over geologic time), or an osmotically-motivated suction of connate water into highly hydrophilic clays or overlying/interbedded sediments, may be responsible for the establishment of what is commonly referred to as a “sub-irreducible” initial water saturation condition.

A reservoir having a sub-irreducible initial water saturation is defined by Bennion, et al. (2000) as a reservoir which exhibits an average initial water saturation less than the irreducible water saturation expected to be obtained for that porous medium at the given column height present in the reservoir above a free water contact (based on a conventional water-gas capillary pressure drainage test). In situations where exceptionally low matrix permeability is present in a gas-producing reservoir, unless a sub-irreducibly saturated original condition is present, the reservoir will exhibit insufficient initial reserves/permeability to be a viable gas-producing candidate. Therefore, Bennion, et al. (2000) believe that, with few exceptions, the vast majority of ultra-low permeability gas reservoirs that would be classified as exhibiting economic gas-producing pay, would fall into this classification of subnormally saturated systems. This phenomenon, they teach, gives rise to one of the most severe potential damage mechanisms in low permeability gas reservoirs: fluid retention or phase trapping.

Bennion, et al. (2000) then teach that “considerable invasion, due to capillary suction effects, can occur when water based fluids are in contact with the formation, even in the absence of a significant overbalance pressure. A phenomena [sic] known as countercurrent capillary imbibition has been well documented in the literature in previous papers and studies by the authors . . . and illustrates how a significant increase in water saturation in the near wellbore or fracture face region can occur in such a situation, even if underbalanced operations are being used when water based fluids (including foams), are circulated in contact with the formation face.” They then propose that this problem can be mitigated by not using water based fluids in drilling, completion, and stimulation. If water based fluids must be used, then they recommend minimizing the exposure time and the depth of water invasion. They then advise that “capillary pressure, which is the dominant variable controlling fluid retention, is a direct linear function of interfacial tension between the water and gas phase. If this interfacial tension can be reduced between the invading water based filtrate and the in-situ reservoir gas, the magnitude of the capillary pressure and the degree of observed fluid retention may also be lessened.” and they teach that “natural capillary imbibition will want to ‘wick’ or imbibe water from the high water saturation zone (encompassing the original invaded area) deeper into the formation, resulting in a ‘smearing’ of the water saturation profile . . . . As long as a recharge source of unbound water is removed from the wellbore or fracture, this will obviously result in a gradual reduction in the value of the trapped water saturation in the near wellbore or fracture face region, which may result in a slow long term improvement in the permeability to gas in the region which previously exhibited near zero gas permeability.” In other words, Bennion, et al. (2000) advise that availability, let alone injection, of water should be minimized, especially if the interfacial tension has been lowered. This is the exact opposite of the methods of many embodiments described herein.

U.S. Pat. No. 7,255,166 to Weiss et al. (hereinafter “Weiss”) discusses a method for stimulation of hydrocarbon production via imbibition by utilization of surfactants. However, the discussed methods rely on the use of fuzzy logic and/or neural network architecture constructs to determine surfactant use. Additionally, Weiss discusses the use of whole cores for an imbibition test, which can be very inefficient, especially for low-permeability materials, and can be inaccurate due to difficulty in analyzing certain effects such as phase trapping. Further, it is likely that the core surfaces have been altered by cutting and/or by drying, oxidation or other weathering processes.

### SUMMARY

It should be recognized that in low permeability sources the conditions which favor release of oil due to imbibition differ from the conditions which favor release of gas due to imbibition. Further, the interfacial tension between oil and water is much lower than the interfacial tension between a gaseous phase and water.

According to some embodiments, a method for enhancing hydrocarbon recovery from a low-permeability formation is provided. A treating fluid is caused to contact the low-permeability formation such that the treating fluid is imbibed by the formation, thereby increasing hydrocarbon recovery. The treating fluid is selected based at least in part on a quantitative determination of porosity of a sample from the low-permeability formation. The selection can also be based on a quantitative determination of permeability of the sample, and on an imbibition test carried out on the sample. The sample is preferably disaggregated formation material. For example, the disaggregated material can be prepared (e.g. using grinding) from a core sample or could be obtained from mines (such as for coalbed methane). The imbibition test can include an estimate of wettability and/or contact angle of the sample and the treatment fluid or an additive.

According to some embodiments, a formation treating fluid is provided for enhancing hydrocarbon recovery from a low-permeability formation. The treating fluid includes at least one constituent selected based at least in part on a quantitative determination of porosity of a sample of material from the low-permeability formation, and imbibition testing carried out on the sample of material and at least one constituent. The selection can also be based on a quantitative determination of permeability of the sample of material. The imbibition testing can include and estimation of wettability and/or contact angle, and the data used should be during a period of steady state imbibition. The sample of material used for the testing is preferably disaggregated material from the low-permeability formation. The constituent can be for example, a surfactant type and concentration selected to achieve an imbibition characteristic so as to increase hydrocarbon recovery.

According to some embodiments, a method of selecting an appropriate treatment fluid for enhancing hydrocarbon recovery from a low-permeability formation is provided. The method includes determining porosity of a first sample of material from the low-permeability formation, for example using specific gravity measurements, and testing the first sample of material for imbibition characteristics for a first candidate fluid. The porosity determination and imbibition testing is repeated for each of one or more subsequent samples of material from the low permeability formation and each of one or more subsequent candidate fluids. A candidate fluid is selected based at least in part on the imbibition testing and porosity determinations. Note that the porosity determination is particularly useful as it can be direct measure of phase trapping. The selected candidate fluid forms at least part of the treatment fluid. Permeability is also preferably determined for each sample of material. The imbibition testing can include estimations of wettability and/or contact angle and can relate mass of imbibed fluid with contact angle, time, and a tortuosity parameter. The contact angle estimation is preferably based on imbibition test data collected while imbibition is determined to be at steady state. Each sample of material is preferably disaggregated formation material, for example by a grinding process.

According to some embodiments, a method is provided of selecting an appropriate wellbore service fluid is for treating a low-permeability subterranean formation penetrated by a wellbore. A portion of the low-permeability subterranean formation is disaggregated, for example by a grinding process, to form disaggregated sample material. The disaggregated sample material is analyzed and a candidate fluid is selected based at least in part on the analysis of the disaggregated sample material. The selected candidate fluid forms at least part of the treatment fluid. The analysis of the disaggregated material can include imbibition testing, and determinations of porosity and permeability, and can yield estimations of wettability and/or contact angle.

As used herein the term “shale” refers to mudstones, siltstones, limey mudstones, and/or any fine grain reservoir where the matrix permeability is in the nanodarcy to microdarcy range.

As used herein the term “gas” means a collection of primarily hydrocarbon molecules without a definite shape or volume that are in more or less random motion, have relatively low density and viscosity, will expand and contract greatly with changes in temperature or pressure, and will diffuse readily, spreading apart in order to homogeneously distribute itself throughout any container.

As used herein the term “supercritical fluid” means any primarily hydrocarbon substance at a temperature and pressure above its thermodynamic critical point, that can diffuse through solids like a gas and dissolve materials like a liquid, and has no surface tension, as there is no liquid/gas phase boundary.

As used herein the term “oil” means any naturally occurring, flammable or combustable liquid found in rock formations, typically consisting of mixture of hydrocarbons of various molecular weights plus other organic compounds such as is defined as any hydrocarbon, including for example petroleum, gas, kerogen, paraffins, asphaltenes, and condensate.

As used herein the term “condensate” means a low-density mixture of primarily hydrocarbon liquids that are present as gaseous components in raw natural gas and condense out of the raw gas when the temperature is reduced to below the hydrocarbon dew point temperature of the raw gas.

### BRIEF DESCRIPTION OF THE FIGURES

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 illustrates a system for enhancing recovery of hydrocarbons from a low-permeability hydrocarbon reservoir, according to some embodiments;

FIG. 2 illustrates a method for determining the constituents of the treating fluid, according to some embodiments;

FIG. 3 illustrates an example of how different treating fluids interact with a reservoir;

FIG. 4 illustrates differences in gas recovery for treating fluids having different formulations, specifically, different surfactants, for a given shale reservoir sample;

FIG. 5 is a flow chart showing a workflow for measuring contact angle of a wetting fluid and a reservoir sample material, according to some embodiments;

FIG. 6 is a graph showing plots of mass of imbibed fluid and a diagnostic plot to determine steady state, according to some embodiments; and

FIG. 7 is a table comparing the resulting advancing contact angles for Caney shale samples determined by the method of slopes and methods according to some embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Shale reservoirs throughout the world are known to contain enormous quantities of gas, but the production mechanisms operative in these reservoirs are poorly understood. Until fairly recently, the wettability of gas reservoirs has not been of much concern. With the exploitation of gas reserves in coal seams and shale, the so-called unconventional reservoirs, the question of wettability takes on greater importance. According to some embodiments gas recovery from shale and similar reservoirs can be greatly improved. The development of methods to efficiently recover gas from shale, benefits from a good understanding of the chemical nature of the shale. Any exploitation of the shale reserves will likely require the introduction of a fluid into the reservoir; how that fluid interacts with the formation depends on the extent to which the fluid wets the formation. In turn, wetting is controlled by the contact angle. The contact angle determines the wettability of a substrate to a fluid brought into contact with it. According to some embodiments, methods are provided to measure the contact angle of a fluid on reservoir material obtained, for example, from drilling or mining. A significant advantage of methods according to some embodiments is that small quantities and irregular shapes of reservoir material can be used.

According to some embodiments, methods are developed which allow good estimates of the advancing contact angle formed between a fluid and a solid material. The advancing contact angle is important as it relates to the processes of spontaneous and forced imbibition of a fluid into a porous medium.

According to some embodiments, provided methods are straight-forward, inexpensive, and make use of only small samples from the reservoir, rather than whole cores. The methods can be calibrated using well-characterized substrates and fluids, and the extension of the method to actual reservoir material has yielded credible results. Additionally, the contact angle has been found to correlate well with another property—the total organic carbon (TOC), which can be determined from well logs.

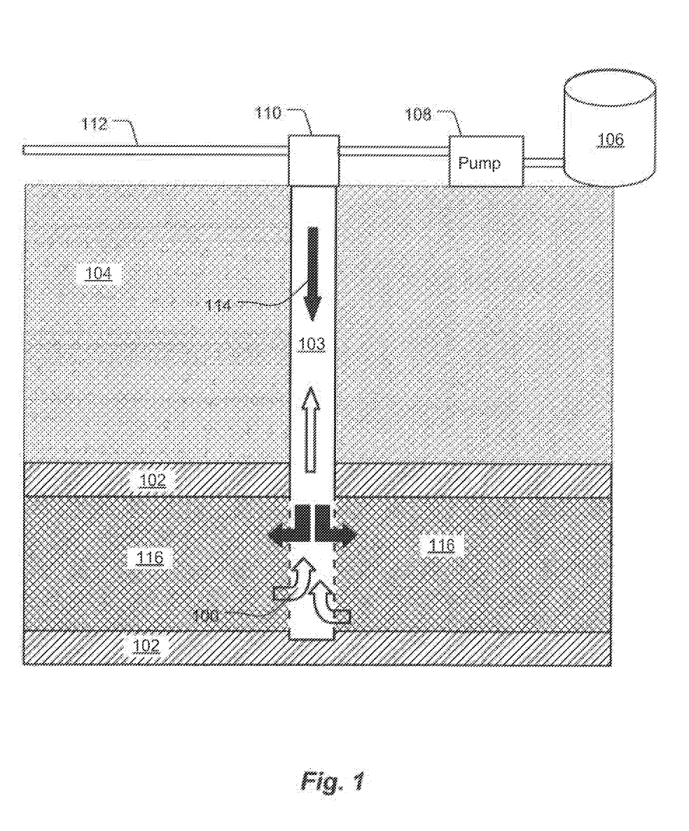

FIG. 1 illustrates a system for enhancing recovery of hydrocarbons (in this example gas 100) from a low permeability hydrocarbon reservoir 102, according to some embodiments. The system utilizes a borehole 103 which is formed by drilling through various layers of rock (collectively, overburden 104), if any, to the low permeability reservoir 102. The reservoir 102 is described as a shale reservoir. However, according to some embodiments other types of reservoirs can benefit. For example, according to some embodiments the reservoir 102 is another type of reservoir having low permeability. It is believed that many of the techniques described herein can practically be applied to any reservoirs having low matrix permeability (i.e. between 100 nanodarcies (nD) and 500 mD, where 1 D=9.87×10⁻¹³ m²).

For gas and/or supercritical fluid producing wells, some embodiments are particularly advantageous when the matrix permeability is less than 1 mD, even more advantageous when the matrix permeability is less than 0.5 mD, even more advantageous when the matrix permeability is less than 0.1 mD, and most advantageous when the matrix permeability is less than 0.01 mD. Some embodiments are particularly advantageous when the matrix permeability is in the nanodarcy range. For oil and/or condensate producing wells, some embodiments are particularly advantageous when the matrix permeability is less than 10 mD, even more advantageous when the matrix permeability is less than 5 mD, even more advantageous when the matrix permeability is less than 1 mD, and most advantageous when the matrix permeability is less than 0.1 mD.

The recovery enhancing system of FIG. 1 includes a fluid storage tank 106, a pump 108, a well head 110, and a gas recovery flowline 112. The fluid tank 106 contains a treating fluid formulated to promote imbibition in the low permeability reservoir 102. For example, the treating fluid may be an aqueous solution including surfactants that result in a surface tension adjusted to optimize imbibition based at least in part on determination or indication of the wettability of the shale, permeability of the shale, or both. The treating fluid 114 is transferred from the tank to the borehole using the pump 108, where the treating fluid comes into contact with the reservoir. The physical characteristics of the treating fluid facilitate migration of the treating fluid into the shale reservoir. In particular, the treating fluid enters the pore space when exposed to the reservoir, e.g., for hours, days, weeks, or longer. Entrance of the treating fluid into the pore space tends to displace gas from the pore space. The displaced gas migrates from a portion of the reservoir 116 to the borehole 103 through the pore space, via the network of natural and/or induced fractures. Within the borehole, the gas moves toward the surface as a result of differential pressure (lower at the surface and higher at the reservoir) and by having a lower density than the treating fluid. The gas is then recovered via the pipe (flowline) at the wellhead. The recovered gas is then transferred directly off site, e.g., via flowline 112.

The principle of operation of the treating fluid is based on capillary pressure. In particular, capillary pressure facilitates imbibition of the treating fluid and displacement of the gas. Capillary pressure can be calculated by the following equation:

$${P}_{c} = \frac{2 γ cos θ}{r} ,$$

where γ represents interfacial tension, θ represents contact angle, and r represents pore radius. As already described, shale exhibits very low matrix permeability. A shale sample exhibiting a matrix permeability of 500 nD may have an average pore radius of only about 2×10⁻⁸ cm. Substituting example values for the interfacial tension, contact angle and pore radius into the equation above yields a capillary pressure in excess of 72,000 kPa, or 10,440 psi. Increasing the contact angle to 60 degrees yields a capillary pressure of 5,220 psi. The capillary pressure causes imbibition of the treating fluid into the shale pore space. Imbibition into either a closed capillary or an infinite capillary results in co-current or counter-current flow, i.e., total flux is zero. Further, co-current or counter-current imbibition will occur when an element of the matrix is completely surrounded by wetting fluid.

It should be noted that capillary pressure as used herein is defined as the difference between the pressures in the wetting and non-wetting fluids. Consequently, the imbibition of the treating fluid will be spontaneous and independent of any positive applied differential pressure.

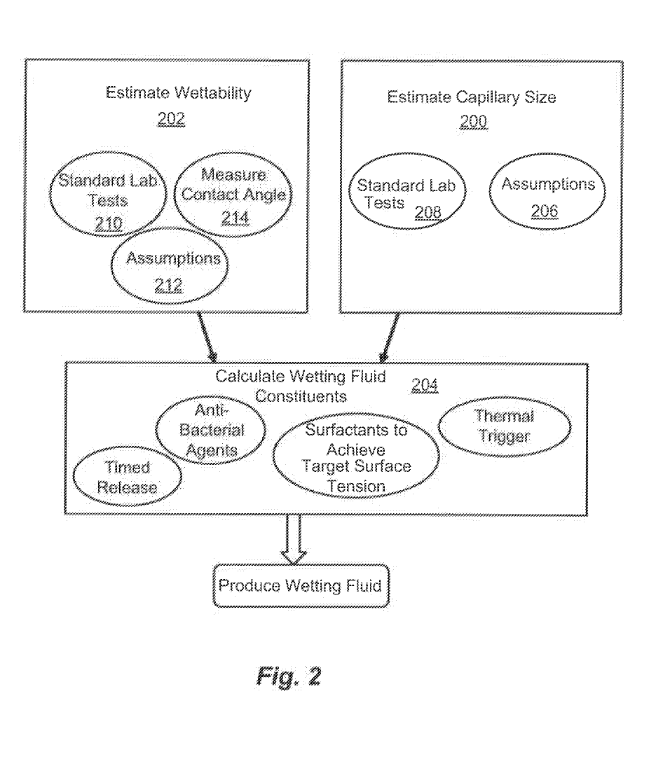

FIG. 2 illustrates a method for determining the constituents of the treating fluid, according to some embodiments. The method includes a first preparatory step 200 of estimating capillary size and/or permeability. Estimation of permeability may be based on examination of samples using standard laboratory techniques as shown in step 208, or assumptions based on pre-existing data or experience (collectively, assumptions 206).

A second preparatory step 202 is estimating formation wettability. Wettability is an indication of the tendency of a fluid to spread on the surface of a substance. At one extreme of wettability the fluid responds to a solid so as to maximize the surface area of the interface between the fluid and solid. At another extreme of wettability the fluid forms a ball, thereby minimizing the interfacial area. Estimation of wettability may be based on examination of samples using standard laboratory techniques, as indicated in step 210, assumptions based on pre-existing data or experience (collectively, assumptions 212), or contact angle measurement 214. The contact angle is the angle, measured through the liquid, formed between the surface of a drop of fluid and the surface of the substance upon which the drop is placed. If the drop readily wets the surface, then the static contact angle will be relatively small. Conversely, if the drop doesn't wet the surface, it will form a ball and the static contact angle will be large. Shale typically exhibits mixed wettability; i.e. they are not completely 100% oil- or water-wet, although this is not to say that they cannot be. Table 1 shows the relationship between wettability and contact angle (static measurement). Given a shale sample that is strongly water-wet, a treating fluid may be formulated such that the contact angle formed between treating fluid and the shale matrix approaches 0 degrees.

TABLE 1
Relationship between static contact angle and wettability

| Contact Angle | Wettability |
|---|---|
| 0°-70° | Strongly water-wet |
| 70°-110° | Intermediate wettability |
| 110°-180° | Strongly oil-wet |

The estimation of wettability is used to determine constituent ingredients (e.g., surfactants) of the treating fluid as shown in step 204. Correlations can then be used to determine the type and concentration of surfactant to be used to achieve enhanced gas recovery. According to some embodiments, further description of techniques for selecting the type and concentration of surfactant is provided herein below. It may also be desirable to include anti-bacterial agents to inhibit growth that would compromise the overall effectiveness of the process. Other constituents may also be selected, including but not limited to scale inhibitors, formation stabilizers, e.g., fines stabilizers and clay stabilizers, oxygen scavengers, antioxidants, iron control agents, corrosion inhibitors, emulsifiers, demulsifiers, foaming agents, anti-foaming agents, buffers, pH adjusters and additives that will alter the available surface area, e.g., by chemical means including but not limited to oxidation and sulfonation.

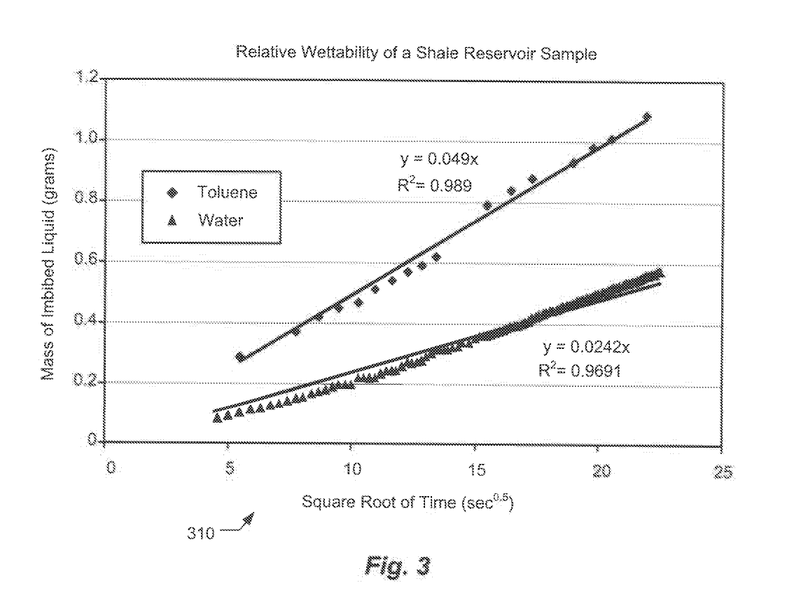

In FIG. 3, plot 310 illustrates an example of how different treating fluids interact with a formation sample. The example is based on black shale formation samples. The treating fluids for this example are water and toluene. Note that the data can be used to determine a quantitative measure of the contact angle, i.e. after a measurement of the permeability of various pack and fluid properties.

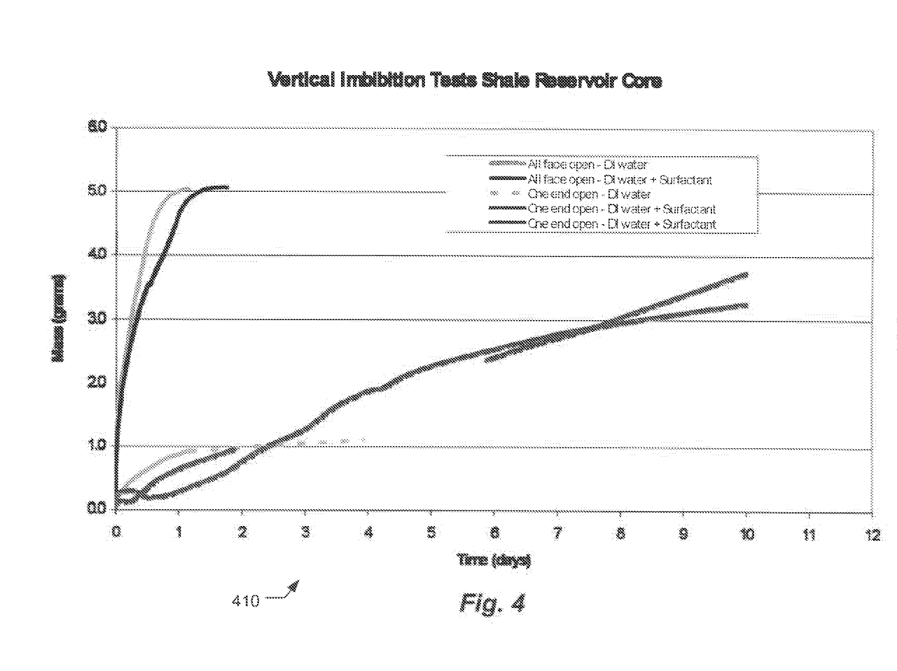

In FIG. 4, plot 410 illustrates differences in gas recovery for wetting fluids having different formulations, specifically, different surfactants, for a given shale reservoir sample. The data show that recovery from “un-treated” cores is significantly less than recovery from “treated” cores, where treatment refers to the use of surfactant in the treating fluid. It should be noted that the un-treated cores yield far lower ultimate gas recovery.

A variation of the technique described above is to delay the release (e.g., by encapsulation, solubility, etc.) of the surfactant altering the wettability in order to reduce or eliminate phase-trapping. Another variation is to use surfactants where the hydrophilic-lipophilic balance (HLB) changes with temperature.

Further description of techniques for selecting the type and concentration of surfactants will now be provided, according to some embodiments. In order to more fully understand the interaction between reservoir material and a fluid brought into contact with the reservoir, one should first determine whether or not the fluid is capable of wetting the reservoir rock. It can be argued that if the fluid is unable to wet the surface of a material, then any chemical alteration would be minimal. The extent to which a fluid wets the surfaces of pores will determine how the fluid either cleans up (drainage) or further penetrates the porous medium by imbibition.

It is generally accepted that the contact angle formed by a fluid introduced onto the surface of a solid is a good measure of the wettability of the solid. In Washburn, E. W., “The Dynamics of Capillary Flow”, The Physical Review, Vol. XVII, No. 3 (1921), one of the earliest models for studying the imbibition of fluid into a porous medium is provided. Over the years, the method has been used to study wetting. Generally, the test involves contacting one end of the porous medium with a liquid and determining the height of the advancing liquid front—above the surface of the test liquid—as a function of time. The method is often referred to as the Capillary Rise Method (CRM), and the process is analogous to the well-known rise of liquids into capillaries which they wet.

For further information regarding use of imbibition testing, see: U.S. Pat. No. 6,929,069, and Hinkel J J, Brown J E, Gadiyar B R and Beyer E: “New Environmentally Friendly Surfactant Enhances Well Cleanup,” paper SPE 82214, presented at the SPE European Formation Damage Conference, The Hague, May 13-14, 2003, both of which are incorporated by reference herein.

Rosen, M. J., “Surfactants and Interfacial Phenomena”, Second Edition, John Wiley & Sons, New York, N.Y. (1989) presents a convenient form of the Washburn equation:

$${l}^{2} = \frac{( kr ) {γ}_{LA} cos θ}{2 η} t \qquad ( 1 )$$

In the eq. (1), l (cm) denotes the height of the imbibing fluid above the surface of test fluid, γ_{LA} (dyn/cm) is the surface tension of the test fluid, θ (degrees) is the contact angle, η (dyn-s/cm²) is the viscosity of the test fluid and t (s) is time. The term kr (cm) relates to the properties of the porous medium. If one were to plot/versus \sqrt{t}, a straight line would be obtained, and the slope of the line would be

$$Slope = \sqrt{\frac{( kr ) {γ}_{LA} cos θ}{2 η}} \qquad ( 2 )$$

It has been customary to determine the contact angle of an unknown fluid by comparing its performance in an imbibition test with that of a baseline fluid, or calibration fluid, whose contact angle is believed to be known. Often, the assumption is made that the baseline fluid wets the porous solid perfectly; this is equivalent to assuming that the fluid forms a contact angle of 0 degrees. Further, the assumption is made that the porous medium is unchanged from test to test; this being the case, then kr will be unchanged.

If two tests were run, one with a fluid with contact angle=0 degrees (Known), and the other with unknown contact angle (Unknown), then the slopes from the plots of l versus \sqrt{t} would be related in the following way:

$$\frac{{Slope}_{U}}{{Slope}_{K}} = \frac{\sqrt{\frac{( kr ) {γ}_{U}}{2 {η}_{U}}}}{\sqrt{\frac{( kr ) {γ}_{K} ( 1 )}{2 {η}_{K}}}} \sqrt{cos {θ}_{U}} = \sqrt{\frac{{γ}_{U} {η}_{K}}{{γ}_{K} {η}_{U}}} \sqrt{cos {θ}_{U}} \qquad ( 3 )$$

It is a simple matter to obtain the physical properties, γ and η of the test fluids, and these combined with the measured slopes can be used to determine a value for the unknown contact angle.

However, a major flaw in the method described above is the assumption that the porous medium will be identical from test to test, i.e. that the term kr remains unchanged. Naturally occurring porous materials can be quite heterogeneous and, as will be shown, even small changes in, for example, porosity will have a major impact on the contact angle.

Another significant flaw in the method described above is the assumption that the ‘known’ fluid will be perfectly wetting, i.e. that the contact angle is 0 degrees, or that the contact angle is known accurately. A comparison of the pore volume determined by pycnometric methods to the pore volume based upon the imbibed mass of a ‘perfectly’ wetting baseline fluid can show a significant discrepancy with the measurement based upon imbibed mass yielding a lower value than expected. Such a finding can be the result of some of the pore volume being closed, but the more likely explanation is that the ‘perfectly’ wetting fluid failed to enter some of the larger pores.

A third disadvantage of the standard method is that it requires two separate imbibition tests. Test material is often scarce. Although a single pack could be used for testing with both the baseline fluid and the test fluid with a drying step after the baseline fluid had been imbibed, this is not preferred due to possible interactions between the baseline fluid and the packing material. Also, such a method requires significantly more time. Obviously a single-step method that also addresses the shortcomings of the earlier procedures will be beneficial.

According to some embodiments, a method of determining a contract angle based upon an alternative formulation of the Washburn equation is provided as follows:

$$m = ρ A \sqrt[4]{8 k {φ}^{9}} \sqrt{\frac{γ}{2 η}} \sqrt{cos θ} \sqrt{t} \qquad ( 4 )$$

The equation (4) above is based upon a conversion of the length/height of the imbibition front to a more easily measured parameter, mass (g) of the imbibant. The fluid density, ρ (g/cm³) has been introduced as well as the cross-sectional area, A (cm²) of the porous medium. When the mass, m, of fluid imbibed is plotted versus the square root of time, Equation. (4) predicts that a straight line will result and the slope of the line is given by

$$slope = ρ A \sqrt[4]{8 k {φ}^{9}} \sqrt{\frac{γ}{2 η}} \sqrt{cos θ} \qquad ( 5 )$$

As shown in Equation (5), the derivation has introduced two measurable quantities: the permeability, k (cm²), and porosity, φ (decimal), to describe the properties of the porous medium, thereby obviating the need to assume that pack properties remain constant. This approach represents a major improvement over the standard Washburn method. The result is general and, therefore, applicable to any porous medium. Whether the porous material is a competent core or a pack of unconsolidated particles will not matter as long as we possess accurate values for the permeability and the porosity.

It has been found that Equation (5) is especially well-suited and calibrated for packs prepared following the procedures described more fully herein below, according to some embodiments. Equation (5), while based upon the well-known bundle of capillaries model, has been made more general by the inclusion of tortuosity in a straightforward way.

Flow through a porous medium is actually ‘tortuous’ meaning that the fluid moving through the medium does not follow a straight path and/or that the capillaries may not be uniform. To estimate the tortuosity value appropriate for the packs under analysis, a series of resistivity measurements can be made.

According to some embodiments, the measurements are carried out on a sample of packed disaggregated material taken from the core, rather than on the whole core. According to some embodiments, using a pack versus whole core has been found to be advantageous for a number reasons. The availability of whole core is very limited. Furthermore, as will be discussed more fully herein below, the ultra-low matrix permeability often found in unconventional reservoirs such as shale, for example, having a matrix permeability well below 0.1 mD would require that test times be very long, or that very large samples be used.

Table 1 shows that the radius of a shale core would have to be impractically large to produce an imbibition flux equivalent to that obtained using a typical pack prepared in the laboratory. Formation material is scarce; therefore, emphasis has been placed upon the use of small samples. Sample sizes on the order of 5 g will be sufficient. It has been found that grinding of the sample will expose sufficient fresh surface area and that the test fluid is exposed to a surface very representative of the rock face of a fresh hydraulic fracture actually found in the reservoir.

TABLE 1
Effect of test medium on imbibition rate

| Porous | Permeability | Porosity | Contact Angle | Slope | Radius |
|---|---|---|---|---|---|
| Medium | (mD) | (decimal) | (degrees) | (g/s^{1/2}) | (cm) |
| Core | 0.0008 | 0.10 | 0 | 0.055 | 7.4 |
| Core | 0.0008 | 0.03 | 0 | 0.055 | 21.2 |
| Pack | 40-60 | 0.46-.62 | 0 | 0.055 | 0.49 |

The combination of low surface area and low permeability presented by a core will, as discussed earlier, demand test times that are much longer than required when using packs of the disaggregated formation material. Additionally, the analysis of data from core testing is far more complicated than when packs are used due primarily to issues related to phase trapping and the dual porosity of most shale.

A potential problem associated with imbibition testing using ultra-low permeability whole core is the far greater likelihood of phase trapping during a test. In the absence of specialized surfactants, phase trapping hinders the imbibition process. The use of a surfactant to minimize phase trapping will likely have a strong effect on the contact angle. Phase trapping will be difficult to model, whereas the model provided herein is elegantly simple. The error introduced by phase trapping would likely result in the formation being classified as more strongly oil-wet than would actually be the case.

There is far greater uncertainty regarding the porosity and permeability of the core, whereas these properties are easily measured as a part of every test conducted using packs. Virtually all shale cores exhibit a significant number of natural fractures and the permeability measured using these cores is therefore a weighted average of the permeability due to fractures and the matrix permeability; analysis of flow through such a system is complex.

According to some embodiments, a sample of disaggregated material is prepared by grinding to a U.S. Standard mesh size of between 140 and 200. It has been found that packs consisting of 140 to 200-mesh shale particles yield permeability less than 100 mD. While care is taken during the preparation of the packing materials, sieving may not yield a true measure of particle sizes and their distribution. It is not uncommon for the particles passing through the sieve to be aggregates of much smaller particles, and this is the likely reason for the low measured permeability of such packs. This is also why using evaluation methods based upon correlations such as the well known Carman-Kozeny relationship will either fail or, at best, yield large errors, due to broad size distributions.

It is believed that the grinding of the core has only minor impact on the surface properties of the material. While the process of grinding alters the reservoir material physically, the fresh surfaces that result from grinding are believed to be quite representative of the chemical nature of the formation in its natural state. Furthermore, the surfaces of samples shaped by drilling or sawing using either oil or water lubricants do not accurately reflect in-situ properties.

Further description of testing apparatus and procedure will now be provided, according to some embodiments. Testing using a packed column of disaggregated particles provides good results. Packs formed with 140- to 200-mesh particle sizes have been found to provide reproducible results and test times using 5 g samples are normally less than 30 minutes. Care should be taken in selecting test times as test times may lead to erroneous results and longer test times are not efficient. For example, it has been found that if the test time is too short, then the steady-state flow assumed in developing model may not occur. Further, the longer test times provide an opportunity for secondary and tertiary effects that might make interpretation more difficult.

Description of the Imbibition Cell: A test cell is custom made having a tube constructed of borosilicate glass, low expansion, diameter: 12 mm±0.2 mm, wall thickness: 1 mm±0.04 mm. A frit is attached to retain the fine, loose pack material. The frit is manufactured of borosilicate glass, low expansion; diameter is 10 mm OD; thickness is 2.5-2.6 mm; pore size is 40-60 micron. The top of the cell has a thread assembly for attaching to a permeameter; thread size: Ace #11, ⅝ inch OD, 7 threads per inch, root diameter of 0.541 inch.

Preparation of the Sample: The sample is ground using a suitable mill such as the SPEXSamplePrep 8000D mixer/mill. The resulting material is dry sieved with 4-inch diameter Stainless Steel Retsch sieves on a Retsch AS200 sieve shaker and the 140-200 mesh size material fraction is retained for the measurement. This mesh size gives a fine powder. It should be noted however, and this is discussed elsewhere, that this sieved material can contain aggregates of fines. The sample is then dried to constant weight; the drying temperature preferably does not exceed the static reservoir temperature.

Measuring the Permeability of the Sample: The gas permeability (k) of the sample pack is measured using nitrogen at three different pressures. The gas permeameter consists of a mass flow meter (such as the Brooks mass flow meter model SLA5860), a mass flow controller (such as the Brooks model SLA5850) and a pressure gauge (such as the Rosemount model 3051) enabling the measurement of the differential pressure (Δp=1-4 psi) of a nitrogen flow (q=0.6-3^{cc}/ₘᵢₙ) through the sample pack. Given the low test pressures, the appropriate form of Darcy's Law should be used to compute the permeability. Klinkenberg effects were found to be negligible due to the relatively high permeability of a typical pack (which would not be the case were ultra-low permeability cores used).

Determining the Porosity of the Sample: The porosity of the pack may be determined in at least two ways: (1) using the volume of the pack at tap density and after centrifugation and the measured specific gravity of the packing material (this is a preferred method); and (2) monitor the level of a strongly wetting fluid, such as hexane, during an imbibition test, stopping the test when the hexane has reached the top of the pack. The volume of hexane imbibed at that point should provide a good estimate of the pore volume.

Performing an Imbibition Test and Determining the Slope: The Imbibition Cell is immersed into the test fluid until the top of the frit is fully submerged. The use of a reservoir with a large surface area ensures that the liquid level will not drop substantially during the test; due to the small volumes of test fluid actually imbibed, a Petri dish has also been found to work very well.

At the beginning of a test, it is common for air to be removed from the frit by counter-current flow as the test fluid enters the frit. Care must be taken to ensure that a bubble does not remain on the frit, because a bubble on the surface of the frit will obstruct the flow of the imbibant resulting in an artificially low imbibition rate. Only when the bottom of the cell is cleared of obstructing bubbles should the test proceed. Begin to record the mass of imbibant flowing into the pack as a function of time. Record the mass every five seconds.

Analyzing the Data from an Imbibition Test: Data analysis is straight-forward. The mass of imbibant, measured in grams, is simply plotted versus the square root of time, measured in seconds. The slope of this line is used to compute the advancing contact angle.

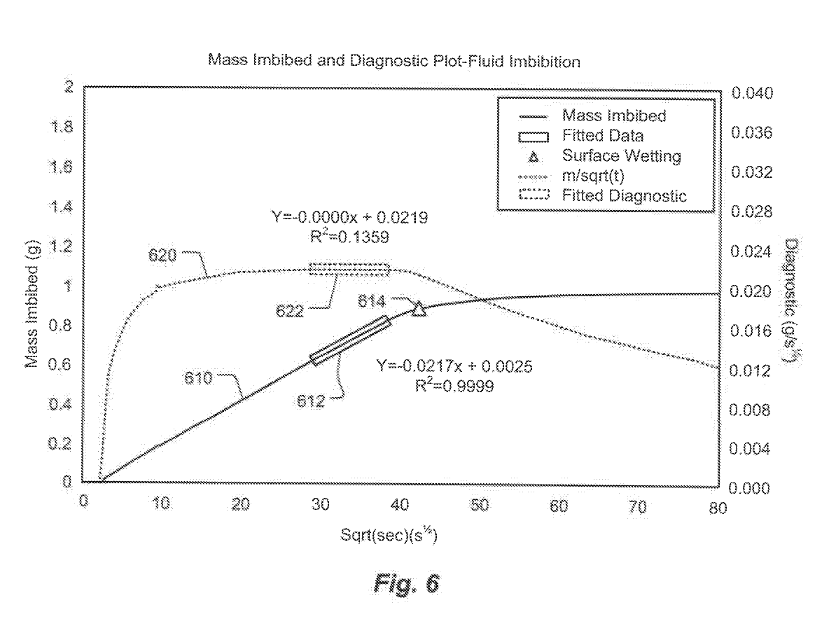

The mass of imbibant divided by the square root of time is also plotted versus the square root of time. This diagnostic plot must at some point in the test yield a line of zero slope. This plot is useful for determining which of the data are to be used to compute the contact angle. If the diagnostic plot fails to reach a region of zero slope, the test data cannot be used. An example of the plots are shown in FIG. 6.

The contact angle can be computed by manipulation of Equation (5):

$$θ = {Arccos ( \frac{Slope}{ρ A \sqrt[4]{8 k {ϕ}^{9}} \sqrt{\frac{γ}{2 η}}} )}^{2} \qquad ( 6 )$$

As is clear from examination of Equation (6), a good estimate of the advancing contact angle greatly relies on accurate values for the porosity and permeability of the pack. A standard error analysis shows that the porosity of the sample can be a major source of error. Advantageously, the methods presented herein require no assumptions regarding pack properties as these will be measured as an integral part of each and every test.

It is important to re-state that the permeability and porosity of the packs created in our studies should not be estimated using particle size distributions as might be obtained by sieving. The Carman-Kozeny model should not be used due to the fact that the actual particles passing through the sieves are typically aggregates of much smaller units.

Further description will now be provided for using the techniques for additive and fluid evaluation, according to some embodiments. In addition to determining the contact angle of the native rock with a fluid such as brine, pure water or other simple fluid, there is a need to quantitatively test methods for determining how various chemical additives in a treatment fluid can change the wetting characteristics of subterranean rock. To address this need, according to some embodiments, methods are provided for testing how surface active agents (surfactants, water soluble polymers and clay stabilizers) can change the wetting condition on the surface of the rock while other physical/chemical processes are taking place in these complex rocks. Fluid and additives can have effects other than modifying the contact angle. For example, additives can impact the magnitude of clay swelling in the rock, chemical weathering of the rock, and modify the native salt environment in the rock. All of these issues can lead to erroneous results and interpretations if not addressed or by applying a conventional Washburn analysis. According to some embodiments, each of these factors are dealt with in turn, which leads to a number of embodiments described below in further detail.

I. Native shale and mudstones often contain swelling clays (smectite and montmorillonite being examples), and as such the texture, three-dimensional structure and pore network of these rocks can be changed by exposure to fluids (particularly water). Also these rocks can be cemented together by soluble or partially soluble cementation agents (calcium carbonate, gypsum being examples). These changes to the rock and pore structure can occur independently of the wetting behavior of the advancing fluid. This is true both for porous rock, and for granulated packs made of these rocks. This effect can complicate the interpretation of Washburn-type experiments—because these experiments assume that the pore structure stays constant for the duration of the experiment.

According to one embodiment, knowledge of both the rock, and the selective use of clay stabilizing ions are used to minimize this complication to the results. Since the surface tension γ is measured independently before the test, the impact of the clay stabilizer on the calculated value for θ can be factored out. Since k, and φ are independently measured for each test prior to the experiment, and since k can be measured after the experiment as well—structural changes to the matrix can be detected.

II. According to some embodiments, pre-treatment of the surfaces of granular material can be used to assist in the differentiation of wetting affects (on the surface of the rock) and the reduction in interfacial fluid tension (between the two mobile phases). This enables distinction between θ and γ in Equation (4).

According to some embodiments, pre-treatment of the pack can also be used to minimize the development of concentration gradients of surface active species in the shale pack. Additives that are highly adsorption prone will likely not move at the same velocity through the pack as the wetting fluid.

In addition to changing the contact angle of surfaces it is known that various additives such as polyacrylamides or polysulphonates can significantly change the permeability and porosity of packs of material due to their ability to instigate agglomeration or dispersion of fine particulate material. As such, the conventional “comparative Washburn” method described above would not work. According to some embodiments, independently measuring permeability k and porosity φ is performed in order to make the pre-treatment embodiment effective and to distinguish wetting effects from other effects.

III. Numerous shale and mudstone formations contain liquid hydrocarbons as well as gas. According to some embodiments, the pack to be tested may have been previously saturated with another liquid. The imbibition test can be run against a constant or variable hydrostatic pressure.

IV. According to one embodiment, the contact angle is determined with respect to a fluid which has a salt concentration(s) that mimics the connate water (or of the connate water diluted by treatment fluid) of the formation.

V. Advantageously, the described methods are pragmatic—for example by providing for high-throughput, rapid, atmospheric pressure testing of fluids/rocks.

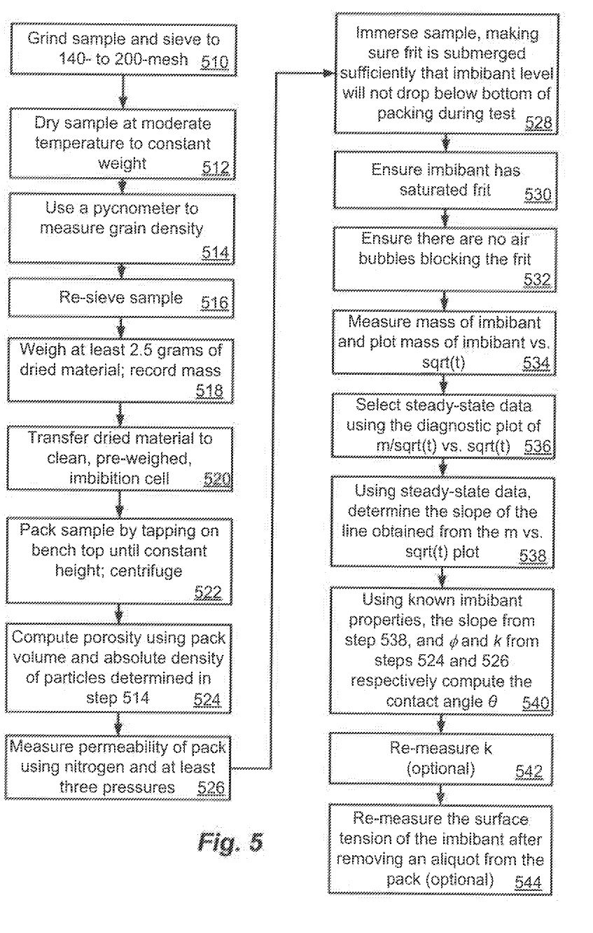

FIG. 5 is a flow chart showing a workflow for measuring contact angle of a wetting fluid and a reservoir sample material, according to some embodiments. In step 510 the sample is ground and sieved to an appropriate particle size. It has been found that 140- to 200-mesh size is suitable for many shale reservoir material. As discussed elsewhere herein, it has been found that the sieved particles may be aggregates of fines. In step 512, the sample is dried at moderate temperature to constant weight. The drying temperature preferably should not be greater than reservoir temperature. In step 514, a pycnometer is used to measure grain density. This technique is accurate and conserves time and sample over alternative embodiments that include performing a second test with hexane. In step 516, the sample is re-sieved.

In step 518, a portion, preferably at least 2.5 grams of dried material is weighed. The measured mass is recorded. In step 520 the dried material is transferred to a clean, pre-weighed, imbibition cell. In step 522 the sample is packed, preferably by tapping on a bench top until it is constant height, and then centrifuged. It has been found that centrifugation of the dry pack at 5000 rpm for 10 minutes is suitable for many applications. The pack height is then recorded.

In step 524 the porosity is computed using pack volume and absolute density of particles determined in step 514. Hexane is often considered to be a good ‘known’ fluid for use in the conventional Washburn method, given its low surface tension, low specific gravity and low viscosity. However, it is believed that the properties of hexane may exacerbate phase trapping, which could account for observed differences in porosity determined by the mass of hexane imbibed when compared to the porosity determined by pack volume and the absolute volume of the pack material. According to some embodiments, fluorocarbon fluids can be used to calibrate the porosity computation step.

In step 526, the permeability of the pack is measured using nitrogen and a least three flow rates/pressures. It has been found that differential pressures of 2, 4, and 8 psi are suitable for many shale materials. Care should be taken to ensure a proper form of Darcy's law is used (compressible fluid at low pressure).

In step 528 the sample is immersed. Care should be taken to ensure that the frit is submerged sufficiently such that the imbibant level will not drop below bottom of the pack during imbibition test. In steps 530 and 532 it has been found that it is useful to ensure that the imbibant has saturated the frit before starting the test, and that there are no air bubbles blocking the frit. Note that bubbles can form as air is removed from frit in counter-current flow.

In step 534, the mass of imbibant is plotted versus the square root of time in seconds. In step 536 steady-state data is selected using the diagnostic plot of m/sqrt(t) vs. sqrt(t). In step 538 steady-state data is used determine the slope of the line obtained from the m vs. sqrt(t) plot. An example of data selected using a diagnostic plot as shown and described with respect to FIG. 6. A least squares fit of the data can be performed on the correct range of data as determined by the diagnostic plot. As a reminder, if the diagnostic plot does not indicate the test has reached steady-state imbibition flow, the test data should not be used. In step 540, using known imbibant properties, the slope from step 538, and φ and k from steps 524 and 526 respectively, compute the contact angle θ.

In an optional step 542, the permeability is re-measured. Finally, in optional step 544 the surface tension of the imbibant is re-measured after removing an aliquot from the pack.

FIG. 6 is a graph showing plots of mass of imbibed fluid and a diagnostic plot to determine steady state, according to some embodiments. Curve 610 is a plot of real time mass imbibed verses the square root of time. Curve 620 is a diagnostic plot of mass imbibed divided by square root of time versus the square root of time. The values of this term are shown on the secondary y-axis on the right side of FIG. 6. The curve 620 should have a zero slope as some point—which is denoted by box 622. The zero slope region of diagnostic curve 620 indicates the time period during the test where steady state flow occurred. According to some embodiments, this zero slope window of the diagnostic curve 620, namely box 622, corresponds to the portion of the data curve 610 where the slope should be calculated to use in determining the contact angle. In this case the box 612 indicates the portion of curve 610 that should be used to determine the contract angle. According to some embodiments, if the diagnostic plot curve fails to reach a region of zero slope, the test data is not used. Note that surface wetting point 614 is also shown in curve 610.

Thus, according to some embodiments, counter-current imbibition provides a method to enhance and optimize production of fluids from low permeability formations. According to some embodiments, an improved method to measure the wettability of a porous medium is provided by determining the contact angle using an improved version of the conventional Washburn method. According to some embodiments, the techniques described herein are particularly applicable to rock having permeability in the nanodarcy range as the laboratory results are scalable to reservoir conditions

According to some embodiments, an improved formulation of the Washburn equation is provided which explicitly incorporates measurements of the porosity and permeability of the porous material obviating the need for the specious assumption that these properties are constant from one test sample to the next.

According to some embodiments, the measurement of the permeability and porosity of the porous medium are incorporated into an imbibition test. According to some embodiments a bundle of capillaries model is corrected for tortuosity effects. According to some embodiments, a simple diagnostic plot to guide data selection is used thereby improving the overall result.

According to some embodiments, grinding of the formation material is performed to expose virgin reservoir surfaces, to speed up the test and improve the overall result. If the grinding procedure is used, the method can make efficient use of remnants of formation material.

According to some embodiments, the improved understanding of wettability is used to evaluate and develop improved treating fluids.

Advantageously, according to some embodiments, the method can provide quantitative results instead of a qualitative comparison such as provided by the conventional Capillary Suction Time (CST) test.

According to some embodiments an estimation of a permeability range and size is made and the particles are classified to achieve this range. As described, it has been found that a U.S. Standard mesh size of between 140 and 200 is suitable for many applications. When designing a test procedure, there is a balance between test time and permeability. Parameters should be chosen so that there is a reasonable period of steady-state flow—preferably as determined by the diagnostic plot. As stated previously, it cannot be assumed that conventional classical relationships can be used to relate particle size accurately to permeability. It has been found that the Carman-Kozeney relationship may be off by several orders of magnitude.

According to some embodiments, the pack itself is weighed rather than the fluid. According to some embodiments clay stabilizers may be used during the test to minimize the impact of swelling clays, mineral dissolution, or textural changes on the wetting measurement.

According to some embodiments, the pack is pretreated with the additive to be tested so as to avoid a concentration gradient through the pack. According to some embodiments, the pack is pretreated so as to distinguish surface-wetting alteration from the alteration due to changes in interfacial tension.

According to some embodiments, the technique can include analyzing imbibition into a pack that is already saturated with a liquid or supercritical phase fluid.

According to some embodiments, the liquid phase permeability can be tested after the experiment using a centrifuge or pack flow method.

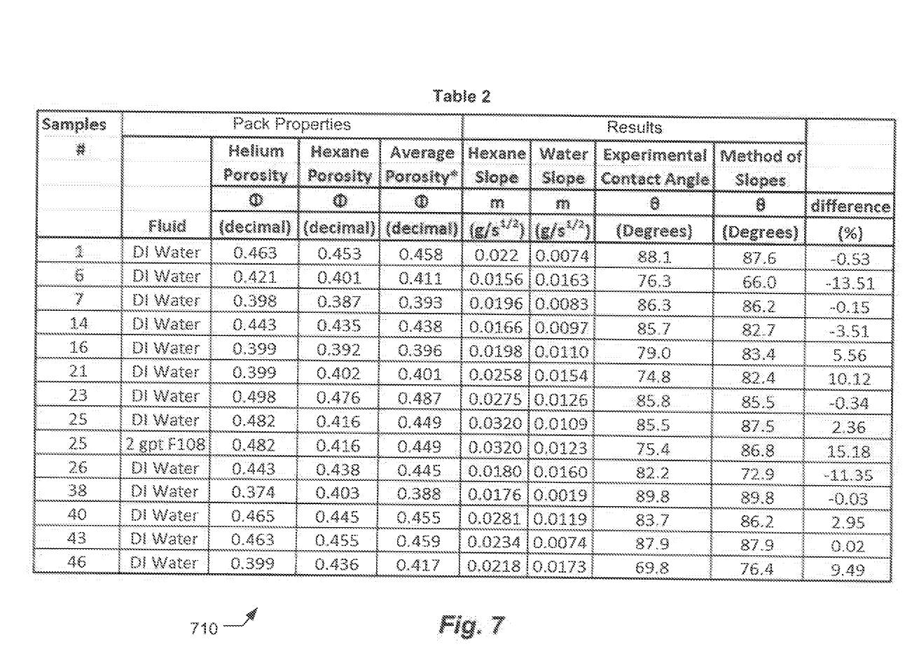

FIG. 7 is a table comparing the resulting advancing contact angles for Caney shale samples determined by the method of slopes and methods according to some embodiments. In particular, table 710 is a table showing the pack properties and results for different samples. As be seen from table 710, while the conventional Washburn method (also referred to as the method of slopes) can provide good results in some cases, large errors can also result. Since the nature of the errors appears to be random rather than systematic, making correction to the Washburn method is impractical or impossible. For example, looking at the case where the method of slopes predicted an advancing contact angle of 75.4 degrees while the improved method yields 86.8 degrees. While the difference between the two results is 15.18%, the consequences are large since cosine (75.4)=0.252; cosine (86.8)=0.056. The ratio of the two results is 4.5. The predicted imbibition rate will vary as the ratio of the square roots and this ratio is 2.12. The impact on production/simulations would be enormous. Thus the conventional Washburn method is not satisfactory.

Note that the use of disaggregated materials for imbibition testing, according to some embodiments, does not require previous knowledge of reservoir permeability, porosity, saturation or production data. However, once these properties are known, the obtained laboratory data can be scaled to field conditions.

It should be noted that although the embodiments have been described with respect to recovery of hydrocarbon from a source formation, according to some embodiments techniques described herein are also applied to a source that is obtained via mining operations, e.g., surface mining or subsurface mining, especially in the case of coal seams (coalbed methane). For example, material obtained from surface mining could be treated with fluid to recover or remove hydrocarbon from the material, such as overburden removed during coal mining operations. According to some embodiments, techniques described herein are also applied to remove pollutants from groundwater.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A method for enhancing hydrocarbon recovery from a low-permeability formation comprising:
causing a treating fluid to contact the low-permeability formation such that the treating fluid is imbibed by the formation, thereby increasing hydrocarbon recovery, wherein the treating fluid is selected based at least in part on a quantitative determination of porosity of a sample from the low-permeability formation.

2. A method according to claim 1 wherein the determination of porosity is based at least in part on specific gravity measurements of the sample.

3. A method according to claim 1 wherein the fluid selection is further based in part on a quantitative determination of permeability of the sample.

4. A method according to claim 3 wherein the selection is further based at least in part on an imbibition test carried out on the sample.

5. A method according to claim 4 wherein the sample of the low-permeability formation is primarily disaggregated material.

6. A method according to claim 4 wherein the imbibition test includes an estimation of wettability of the sample by the treatment fluid or an additive and using the quantitative determination of porosity and permeability.

7. A method according to claim 4 wherein the imbibition test includes an estimation of contact angle of the sample and the treatment fluid or an additive using the quantitative determination of porosity and permeability.

8. A method according to claim 4 wherein the treating fluid selection includes selecting one or more constituents of said treating fluid based on said imbibition test.

9. A method according to claim 1 wherein the recovered hydrocarbon comprises a gas or a supercritical fluid.

10. A method according to claim 9 wherein said low-permeability formation has a reservoir matrix permeability of less than 0.1 mD.

11. A method according to claim 10 wherein said low-permeability formation has a reservoir matrix permeability of less than 1 micro Darcy.

12. A method according to claim 1 wherein the recovered hydrocarbon comprises an oil or a condensate.

13. A method according to claim 12 wherein said low-permeability formation has a reservoir matrix permeability of less than 0.1 mD.

14. A method according to claim 1 wherein the treating fluid selection includes selecting a surfactant type and concentration to achieve the desired imbibition in order to increase hydrocarbon recovery.

15. A method according to claim 1 wherein the low-permeability formation is a subterranean formation penetrated by a wellbore.

16. A formation treating fluid for enhancing hydrocarbon recovery from a low-permeability formation comprising at least one constituent selected based at least in part on a quantitative determination of porosity of a sample of material from the low-permeability formation, and imbibition testing carried out on the sample of material and the at least one constituent.

17. A fluid according to claim 16 wherein the formation is a low-permeability subterranean formation penetrated by a wellbore.

18. A fluid according to claim 16 wherein the at least one constituent is selected based in part on a quantitative determination of permeability of the sample of material.

19. A fluid according to claim 16 wherein the imbibition testing includes an estimation of wettability the sample of material and a fluid containing the at least one constituent, the estimation of wettability being based in part on the determination of porosity of the sample, and the constituent selection being based in part on the estimation of wettability.

20. A fluid according to claim 16 wherein the imbibition testing includes an estimation of contact angle for the sample of material and a fluid containing the at least one constituent, the estimation of contact angle being based in part on the determination of porosity of the sample, and the constituent selection being based in part on the estimation of contact angle.

21. A fluid according to claim 20 wherein the estimation of contact angle is based on imbibition test data collected while imbibition is believed to be at steady state.

22. A fluid according to claim 16 wherein the sample of material is disaggregated material from a sample of the low-permeability formation.

23. A fluid according to claim 16 wherein low-permeability formation has a matrix permeability of less than 0.1 mD.

24. A fluid according to claim 16 wherein at least one constituent includes a surfactant of a type and concentration selected to achieve an imbibition characteristic so as to increase hydrocarbon recovery.

25. A method of enhancing hydrocarbon recovery from a subterranean formation penetrated by a wellbore, the method comprising:
providing a treatment fluid according to claim 16; and
pumping the fluid through the wellbore and into the subterranean formation so as to treat the formation.

26. A system for enhancing hydrocarbon recovery from a low-permeability subterranean formation penetrated by a wellbore comprising:
a container that stores a treatment according to claim 16; and
a pumping system adapted and configured to transfer the wellbore service fluid from the container and into the wellbore and the low-permeability formation.

27. A method of selecting an appropriate treatment fluid for enhancing hydrocarbon recovery from a low-permeability formation, the method comprising:
determining porosity of a first sample of material from the low-permeability formation;
testing the first sample of material for imbibition characteristics for a first candidate fluid;
repeating the determining of porosity and testing imbibition characteristics for each of one or more subsequent samples of material from the low permeability formation and each of one or more subsequent candidate fluids; and
selecting a candidate fluid based at least in part on the imbibition testing and porosity determinations, the selected candidate fluid forming at least part of the treatment fluid.

28. A method according to claim 27 wherein the formation is a low-permeability subterranean formation penetrated by a wellbore.

29. A method according to claim 27 further comprising determining permeability of the first sample of material each of the one or more subsequent samples of material, wherein the selecting is performed based in part on the permeability determinations.

30. A method according to claim 27 wherein the porosity determinations are made based at least in part on specific gravity measurements of the samples of material.

31. A method according to claim 27 wherein each testing for imbibition characteristics includes an estimation of wettability of each sample of material and candidate fluid, each estimation of wettability being based in part on the determination of porosity of the sample, and the selecting a candidate fluid being based in part on the estimations of wettability.

32. A method according to claim 27 wherein each testing for imbibition characteristics includes an estimation of contact angle for each sample of material and candidate fluid, each estimation of contact being based in part on the determination of porosity of the sample, and the selecting a candidate fluid being based in part on the estimations of contact angle.

33. A method according to claim 32 wherein each testing for imbibition characteristics includes relating mass of imbibed fluid with at least contact angle and time.

34. A method according to claim 33 wherein the relation of mass of imbibed fluid with contact angle also includes a parameter representing tortuosity of the samples of material.

35. A method according to claim 34 wherein the parameter representing tortuosity is based at least in part on one or more resistivity measurements.

36. A method according to claim 32 wherein the estimation of contact angle is based on imbibition test data collected while imbibition is believed to be at steady state.

37. A method according to claim 36 wherein a diagnostic plot is used to estimate when the imbibition is at steady state.

38. A method according to claim 27 further comprising disaggregating portions of the low-permeability formation to form disaggregated material, wherein the first and one or more subsequent samples of material used in the imbibition testing is the disaggregated material.

39. A method according to claim 38 wherein the disaggregation includes a grinding process.

40. A method according to claim 27 wherein the recovered hydrocarbon includes a gas or a supercritical fluid.

41. A method according to claim 40 wherein low-permeability formation has a matrix permeability of less than 0.1 mD.

42. A method according to claim 27 further comprising selecting at least one constituent of the treatment fluid that is selected from the group which consisting of: scale inhibitors, formation stabilizers, fines stabilizers, clay stabilizers, oxygen scavengers, antioxidants, iron control agents, corrosion inhibitors, emulsifiers, demulsifiers, foaming agents, anti-foaming agents, buffers, pH adjusters and other additives that will alter the available surface area.

43. A method according to claim 42 wherein the selected candidate fluid includes a surfactant, and type and concentration of the surfactant used in the treatment fluid is selected to achieve an imbibition characteristic so as to increase hydrocarbon recovery.

44. A method according to claim 27 wherein the imbibition testing includes the use of clay stabilizers to minimize the impact of swelling clays, mineral dissolution, and/or textural changes during the testing.

45. A method according to claim 27 wherein the first sample of material and the one or more subsequent samples of material are treated prior to the imbibition testing with an additive so as to decrease concentration gradients through each sample of material.

46. A method of treating the low-permeability subterranean formation comprising:
providing a wellbore service fluid selected according to claim 28; and
pumping the fluid through the wellbore and into the subterranean formation so as to treat the formation thereby enhancing hydrocarbon recovery from the formation.

47. A system for enhancing hydrocarbon recovery from a low-permeability subterranean formation comprising:
a container that stores a treating fluid, said treading fluid selected according to claim 28; and
a pumping system adapted and configured to transfer the treating fluid from the container and into the wellbore and the low-permeability formation so as to treat the formation thereby enhancing hydrocarbon recovery from the formation.

48. A method of selecting an appropriate wellbore service fluid for treating a low-permeability subterranean formation penetrated by a wellbore comprising:
disaggregating a portion of the low-permeability subterranean formation to form disaggregated sample material;
analyzing the disaggregated sample material; and
selecting a candidate fluid based at least in part on the analysis of the disaggregated sample material, the selected candidate fluid forming at least part of the treatment fluid.

49. A method according to claim 48 wherein the analysis includes imbibition testing of the disaggregated sample material with the candidate fluid.

50. A method according to claim 49 further comprising determining porosity of the disaggregated sample material, wherein the candidate fluid selection is based in part on the determined porosity.

51. A method according to claim 50 wherein the imbibition testing includes and estimation of contact angle for the disaggregated sample material and the candidate fluid and based in part on the determined porosity.

52. A method according to claim 51 wherein the imbibition testing and estimation of wettability of the disaggregated sample material with the candidate fluid, the estimation of wettability being based at least in part on the estimation of contact angle.

53. A method according to claim 51 wherein the estimation of contact angle is based on imbibition testing data collected while imbibition is believed to be at steady state.

54. A method according to claim 49 further comprising determining permeability of the disaggregated sample material, wherein the candidate fluid selection is based in part on the determined permeability.

55. A method according to claim 48 wherein the disaggregating includes grinding of the portion of the low-permeability formation to form the disaggregated sample material.

56. A method according to claim 55 wherein the disaggregating includes sieving through mesh having a size of between about U.S. Standard mesh size 140 and U.S. Standard mesh size 200.

57. A method according to claim 48 wherein the wellbore service fluid enhances hydrocarbon recovery.

58. A method according to claim 57 wherein the recovered hydrocarbon includes a gas or a supercritical fluid.

59. A method according to claim 58 wherein low-permeability formation has a matrix permeability of less than 0.1 mD.

60. A method of treating subterranean formation penetrated by a wellbore the method comprising:
providing a wellbore service fluid selected according to claim 48; and
pumping the fluid through the wellbore and into the subterranean formation so as to treat the formation.

61. A system for enhancing hydrocarbon recovery from a low-permeability subterranean formation penetrated by a wellbore comprising:
a container that stores a treating fluid, said treading fluid selected according to claim 48; and
a pumping system adapted and configured to transfer the treating fluid from the container and into the wellbore and the low-permeability formation.
